(19) United States
(12) Patent Application Publication
(10) Pub. No.: US 2007/0212140 A1
(43) Pub. Date: Sep. 13, 2007

(54) Simplex and duplex continuous automatic document feeder

(75) Inventors: Aihua Xu, Jiangsu Province (CN); Quan Hong, Jiangsu Province (CN)

Correspondence Address: BIRCH STEWART KOLASCH & BIRCH, PO BOX 747, FALLS CHURCH, VA, 22040-0747, US

(73) Assignee: A VISION INC.

(21) Appl. No.: 11/705,758

(22) Filed: Feb. 14, 2007

(30) Foreign Application Priority Data
Mar. 7, 2006 (TW) 095107505

(51) Int. Cl. G03G 15/00

(52) U.S. Cl. 399/367; 399/374

(57) ABSTRACT

A simplex and duplex continuous automatic document feeder includes a sheet input tray in which a sheet is placed before the sheet is fed, a first sheet output tray in which the sheet, after being fed, is placed, an image processing region in which the sheet is processed, a sheet input passageway communicating the sheet input tray with the image processing region, a turning passageway having a front end and a rear end both communicating with the image processing region, a sheet output passageway communicating the image processing region with the first sheet output tray, and a sheet-feeding mechanism for transporting the sheet from the sheet input tray to the first sheet output tray across the image processing region.

### BACKGROUND OF THE INVENTION

1. Field of Invention

The invention relates to a simplex and duplex continuous automatic document feeder, and more particularly to an automatic document feeder capable of transporting a sheet continuously so that an image processing procedure such as scanning can be carried out.

2. Related Art

FIG. 1 is a schematic illustration showing a sheet transporting path of a conventional automatic document feeder. Referring to FIG. 1, a conventional duplex scanner has a single scanning module 200 and an automatic document feeder for turning a document thrice and transporting the document across a scanning region 210 thrice when the scanning module 200 is scanning the document. When the document is transported across the scanning region 210 at the first time, a front side of the document is scanned, and the transporting path of the document is ABCDE. When the document is transported across the scanning region 210 at the second time, a backside of the document is scanned, and the transporting path of the document is EDFBCDE. When the document is transported across the scanning region 210 at the third time, the scanning module 200 does not perform any scanning operation, and the transporting path of the document is EDFBCDE. So, the third document transporting operation is carried out in order to keep the same order of the documents.

Thus, the transporting rollers around the point E have to be reversed so that the ejected document can be transported again. The mechanism is complicated, the overall transporting processes are not smooth, and the time for transporting the document is further lengthened.

### SUMMARY OF THE INVENTION

It is therefore an object of the invention to provide an automatic document feeder capable of continuously transporting a sheet so that an image processing procedure such as scanning can be carried out.

To achieve the above-identified object, the invention provides a simplex and duplex continuous automatic document feeder including a sheet input tray, a first sheet output tray, an image processing region, a sheet input passageway, a turning passageway, a sheet output passageway and a sheet-feeding mechanism. A sheet is placed in the sheet input tray before the sheet is fed. The sheet, after being fed and processed, is stored in the first sheet output tray. The sheet is processed in the image processing region. The sheet input passageway communicates the sheet input tray with the image processing region. The turning passageway has a front end and a rear end, both of which communicate with the image processing region. The sheet output passageway communicates the image processing region with the first sheet output tray. The sheet-feeding mechanism transports the sheet from the sheet input tray to the first sheet output tray through the image processing region.

The automatic document feeder may further include a switching and guiding mechanism for selectively cutting the turning passageway and guiding the sheet in the turning passageway to the first sheet output tray.

Alternatively, the automatic document feeder may further include a second sheet output tray and a switching and guiding mechanism. In a single-sided image processing procedure, the sheet, after being processed at the image processing region once, is placed in the second sheet output tray. In a double-sided image processing procedure, the sheet, after being processed at the image processing region twice, is placed in the first sheet output tray. The switching and guiding mechanism can selectively cut the turning passageway and guide the sheet in the turning passageway to the second sheet output tray.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic illustration showing a sheet transporting path of a conventional automatic document feeder;

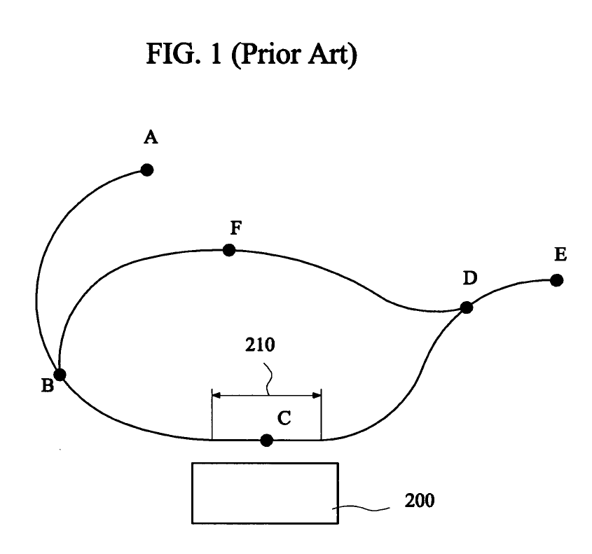

FIG. 2 is a schematic illustration showing a simplex and duplex continuous automatic document feeder according to a first embodiment of the invention;

FIG. 3 is a top view showing an arrangement of a transparent platen, a transparent member and two elastic pieces of FIG. 2; and

FIG. 4 is a schematic illustration showing a simplex and duplex continuous automatic document feeder according to a second embodiment of the invention.

### DETAILED DESCRIPTION OF THE INVENTION

The present invention will be apparent from the following detailed description, which proceeds with reference to the accompanying drawings, wherein the same references relate to the same elements.

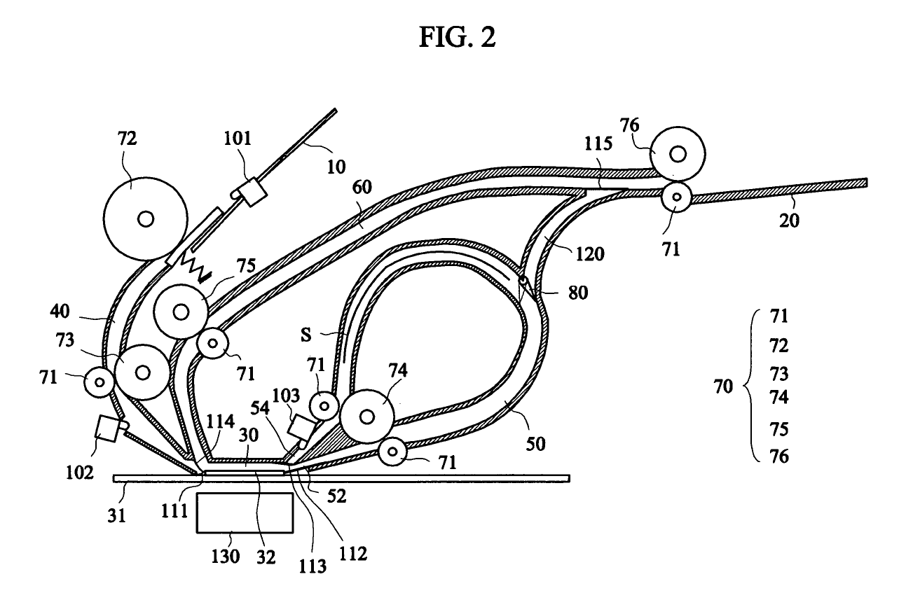

FIG. 2 is a schematic illustration showing a simplex and duplex continuous automatic document feeder according to a first embodiment of the invention. Referring to FIG. 2, the simplex and duplex continuous automatic document feeder of this embodiment includes a sheet input tray 10, a first sheet output tray 20, an image processing region 30, a sheet input passageway 40, a turning passageway 50, a sheet output passageway 60 and a sheet-feeding mechanism 70. A sheet S or a plurality of sheets S is/are stored in the sheet input tray 10 after the sheet or sheets is/are fed. The sheet S, after being fed and processed, is stored in the first sheet output tray 20. The sheet S is processed in the image processing region 30 for an image processing procedure, such as image scanning or printing procedure. That is, in the image processing procedure, an image of the sheet S is acquired or data is printed on the sheet S.

The sheet input passageway 40 communicates the sheet input tray 10 with the image processing region 30. The turning passageway 50 has a front end 52 and a rear end 54. The front end 52 and the rear end 54 communicate with the image processing region 30. The sheet output passageway 60 communicates the image processing region 30 with the first sheet output tray 20. The sheet-feeding mechanism 70 transports the sheet S from the sheet input tray 10 to the first sheet output tray 20 through the image processing region 30. The sheet-feeding mechanism 70 includes a plurality of driven rollers 71 and a plurality of driving rollers 72 to 76.

In order to control the position of the sheet S, this automatic document feeder may further include a plurality of sheet detectors 101 to 103 for detecting the sheet S being fed. The sheet detectors 101 to 103 are respectively disposed in the sheet input tray 10, the sheet input passageway 40 and the turning passageway 50.

In order to guide the sheet S to move smoothly, this automatic document feeder may further include a plurality of elastic pieces (e.g., Mylars) 111 to 115 for assisting in guiding the sheet S from the sheet input passageway 40 to the image processing region 30, from the image processing region 30 to the turning passageway 50, from the turning passageway 50 to the image processing region 30, from the image processing region 30 to the sheet output passageway 60 and from the sheet output passageway 60 to the first sheet output tray 20, and for preventing the sheet S, which is transported from the image processing region 30 to the sheet output passageway 60, from entering the sheet input passageway 40.

The automatic document feeder may further be equipped with a scanning module 130 to become a scanning device. The scanning module 130 is disposed to face the image processing region 30 to read the sheet and generates a corresponding image.

In order to shorten the time for the scanning procedure, the automatic document feeder may further include a switching and guiding mechanism 80 for selectively cutting the turning passageway 50 and guiding the sheet S in the turning passageway 50 to the first sheet output tray 20.

It is to be noted that when the switching and guiding mechanism 80, a bypass passageway 120 and the elastic piece 1 15 do not exist, the automatic document feeder still can carry out the sheet transporting operation for the simplex and duplex scanning operations. In the simplex scanning operation, the sheet S is to be transported across the image processing region 30 twice, but the scanning module 130 does not scan the sheet when the sheet is transported across the image processing region 30 at the first or second time.

The detailed operations of the automatic document feeder will be described in the following. First, the sheet detector 101 in the sheet input tray 10 detects the sheet. Then, the first sheet in the sheet input tray 10 is fed to the sheet input passageway 40 by the roller 72 and transported across the rollers 73 and 71. Then, the first sheet moves past the sheet detector 102, pushes the elastic piece 114 away and then reaches the image processing region 30 under the guidance of the elastic piece 111. The sheet detector 102 outputs a signal according to which the scanning module 130 is instructed to acquire the image after a predetermined period of time. Then, the elastic piece 112 guides the sheet to the turning passageway 50 and the rollers 74 and 71 transport the sheet.

In the simplex scanning operation, the switching and guiding mechanism 80 is located at the position indicated by the dashed line, and the switching and guiding mechanism 80 guides the sheet to the bypass passageway 120, which may be one part of the switching and guiding mechanism 80 and communicates the turning passageway 50 with the first sheet output tray 20, and the sheet pushes the elastic piece 115 away and then enters the sheet output passageway 60. Then, the rollers 76 and 71 transport the sheet to the sheet output tray 20.

In the duplex scanning operation, the switching and guiding mechanism 80 is located at the position indicated by the solid line, and the sheet is guided by the switching and guiding mechanism 80 to turn and then moves past the rollers 74 and 71 and the sheet detector 103. The sheet detector 103 outputs a signal according to which the scanning module 130 is instructed to start acquiring an image of the sheet after a predetermined period of time. Next, the sheet pushes the elastic piece 113 away and then enters the image processing region 30 again. The scanning module 130 further acquires the image again, and then sheet is guided by the elastic piece 114 to enter the sheet output passageway 60. The elastic piece 114 is disposed to prevent the sheet S, which is transported from the image processing region 30 to the sheet output passageway 60, from entering the sheet input passageway 40. Next, the sheet passes through the rollers 75 and 71, and then is guided by the elastic piece 115 to pass through the rollers 76 and 71 and then reach the sheet output tray 20.

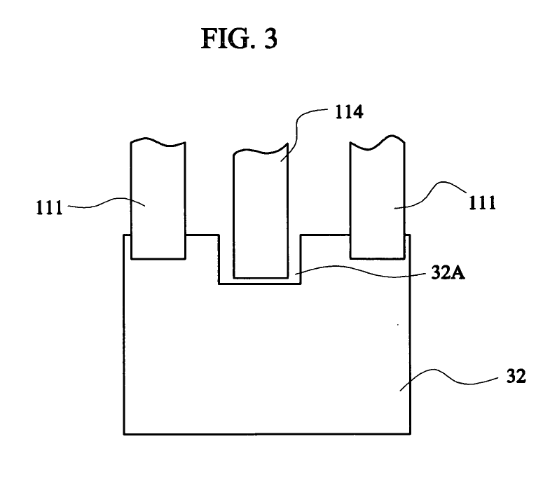

The image processing region 30 is located at a transparent member 32 which contacts with a transparent platen 31. The elastic pieces 114 and 111 may look like to interfere with each other in FIG. 2. However, the elastic piece 111 may actually be disposed on either side of the elastic piece 114, and the elastic piece 111 crosses over the transparent member 32. That is, the free end of the elastic piece 111 is higher than the transparent member 32. The free end of the elastic piece 114 is inserted to a step between the upper surface of the transparent member 32 and the upper surface of the transparent platen 31, as shown in FIG. 3. That is, the free end of the elastic piece 114 is lower than the transparent member 32 and extends to a notch 32A of the transparent member 32. Alternatively, the elastic piece 114 may be disposed on either side of the elastic piece 111, and detailed descriptions thereof will be omitted.

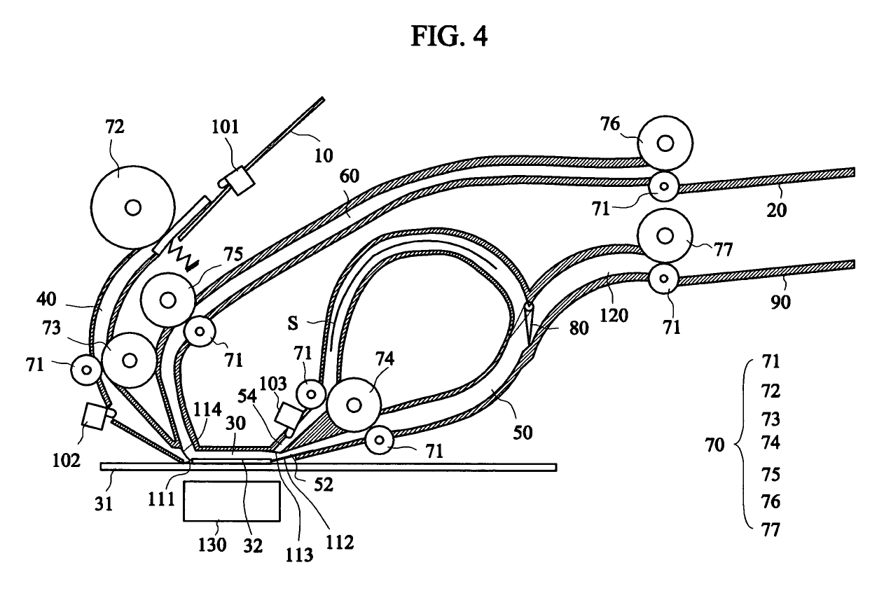

FIG. 4 is a schematic illustration showing a simplex and duplex continuous automatic document feeder according to a second embodiment of the invention. As shown in FIG. 4, this embodiment is similar to the first embodiment except that the automatic document feeder of this embodiment further includes a second sheet output tray 90, a switching and guiding mechanism 80 and a set of rollers 77 and 71. The second sheet output tray 90, communicating with the turning passageway 50, is for storing the sheet S after the sheet S is processed at the image processing region 30 once in the single-sided image processing procedure. The first sheet output tray 20 is for storing the sheet S after the sheet S is processed at the image processing region 30 twice in the double-side image processing procedure. The switching and guiding mechanism 80 may selectively cut the turning passageway 50 and guide the sheet S in the turning passageway 50 to the second sheet output tray 90. Thus, the second embodiment does not need the elastic piece 115 of the first embodiment any more. Consequently, the documents after being processed in the simplex operation and the duplex operation may be sorted. If the user finds that the document scanned in the duplex operation is placed in the second sheet output tray 90, he or she would realize that the simplex operation has been executed and correct the operation mode if necessary.

Because the sheet-feeding mechanism continuously transports the sheet without reversing the sheet, the time for transporting the sheet may be shortened and the structure of the sheet-feeding mechanism may be simplified. In addition, the provision of the sheet detector can effectively control the second sheet to enter the scanning region immediately after the first sheet is separated from the scanning region in the duplex operation so as to speed up the operation. Furthermore, after a stack of sheets is scanned in a simplex or duplex operation, the order of the sheets still can be kept unchanged or even two sheet output trays can be used to sort the sheets scanned in the simplex and duplex operations. Thus, a human-oriented operating method can be provided.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. A simplex and duplex continuous automatic document feeder, comprising:
a sheet input tray in which a sheet is placed before the sheet is fed;
a first sheet output tray in which the sheet is placed after the sheet is fed;
an image processing region in which the sheet is processed;
a sheet input passageway communicating the sheet input tray with the image processing region;
a turning passageway having a front end and a rear end both communicating with the image processing region;
a sheet output passageway communicating the image processing region with the first sheet output tray; and
a sheet-feeding mechanism for transporting the sheet from the sheet input tray to the first sheet output tray through the image processing region.

2. The feeder according to claim 1, wherein an image of the sheet is acquired at the image processing region.

3. The feeder according to claim 1, wherein data is printed on the sheet at the image processing region.

4. The feeder according to claim 1, further comprising a plurality of sheet detectors for detecting the sheet being fed.

5. The feeder according to claim 4, wherein the sheet detectors are disposed in the sheet input tray, the sheet input passageway and the turning passageway.

6. The feeder according to claim 1, further comprising a plurality of elastic pieces for assisting in guiding the sheet from the sheet input passageway to the image processing region, from the image processing region to the turning passageway, from the turning passageway to the image processing region and from the image processing region to the sheet output passageway, and preventing the sheet, which is transported from the image processing region to the sheet output passageway, from entering the sheet input passageway.

7. The feeder according to claim 1, wherein the sheet-feeding mechanism comprises a plurality of rollers.

8. The feeder according to claim 1, further comprising:
a scanning module, which is disposed to face the image processing region, for scanning an image of the sheet.

9. The feeder according to claim 1, further comprising:
a switching and guiding mechanism for selectively cutting the turning passageway and guiding the sheet in the turning passageway to the first sheet output tray.

10. The feeder according to claim 9, wherein the switching and guiding mechanism comprises a bypass passageway communicating the turning passageway with the first sheet output tray.

11. The feeder according to claim 1, further comprising:
a second sheet output tray, communicating with the turning passageway, for storing the sheet after the sheet is processed at the image processing region once, wherein the first sheet output tray is for storing the sheet after the sheet is processed at the image processing region twice; and
a switching and guiding mechanism for selectively cutting the turning passageway and guiding the sheet in the turning passageway to the second sheet output tray.

12. The feeder according to claim 11, wherein the switching and guiding mechanism comprises a bypass passageway communicating the turning passageway with the second sheet output tray.
